(19) United States
(12) Patent Application Publication
(10) Pub. No.: US 2026/0170311 A1
(43) Pub. Date: Jun. 18, 2026

(54) SYSTEM AND METHOD FOR EXPERT BENCHMARKING OF SYSTEM-GENERATED AI-ASSISTED RESPONSES

(71) Applicant: JustAnswer LLC, Covina, CA (US)

(72) Inventors: Andrew Kurtzig, Covina, CA (US); Vladyslav Mysla, Covina, CA (US); Joseph Cera, Covina, CA (US)

(21) Appl. No.: 19/418,766

(22) Filed: Dec. 12, 2025

Related U.S. Application Data
(60) Provisional application No. 63/733,358, filed on Dec. 12, 2024.

(51) Int. Cl. G06N 3/0475; G06N 3/042; G06N 3/045

(52) U.S. Cl. CPC G06N 3/0475; G06N 3/042; G06N 3/045

(57) ABSTRACT

Methods, systems, and a device are disclosed using a server communicatively coupled to a computer network, the server configured to: receive, at the server, a query; pass the query to a generative AI query model; receive, from the generative AI query model, a response; pass the query and the response to a classification AI model; receive, by the classification AI model, a classification of the query and the response generated by the generative AI query model; in response to the classification of the query and the response, match the query and the response to a field of technical expertise; receive information in response to an interaction with an interactive user interface element; and generate a signal at the server to establish an electronic communication connection, using the information received in response to an interaction with the interactive user interface element.

### CROSS-REFERENCE TO RELATED APPLICATIONS

This application claims the benefit of U.S. Provisional Patent Application No. 63/733,358 (Attorney Docket No.: 57669-0068P01), filed Dec. 12, 2024, which is incorporated herein by reference in its entirety.

### BACKGROUND

Machine learning models receive an input and generate an output, e.g., a predicted output, based on the received input. Some machine learning models are parametric models and generate the output based on the received input and on values of the parameters of the model. Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

Disclosed herein is a system and method for expert verification of system-generated AI-responses. One aspect of the disclose includes a system. The system includes server communicatively coupled to a computer network, the server configured to: receive, at the server, a query; pass the query to a generative artificial intelligence (AI) query model; receive, from the generative AI query model, a response; pass the query and the response to a classification AI model; receive, by the classification AI model, a classification of the query and the response generated by the generative AI query model; in response to the classification of the query and the response, match the query and the response to a field of technical expertise; receive information in response to an interaction with an interactive user interface element; and generate a signal at the server to establish an electronic communication connection, using the information received in response to the interaction with the interactive user interface element, between a first user device and a second user device.

The system's server is configured to: output, using the field of technical expertise that is matched to the classification of the query and the response, an interactive user interface element to the second user device.

The system's server is configured to: receive query data from the second user device and transmit the query to the generative AI query model; and receive one or more output parameters from the generative AI query model and the classification AI model, the one or more output parameters including instructions for the first user device.

The system's server includes: an output processor electronically coupled to an analyzer, the output processor configured to: i) convert the one or more output parameters to computer-readable instructions before transmission to the first user device, and ii) convert at least one score received from the first user device to one or more input parameters configured for transmission by the output processor to facilitate retraining of one or more of the generative AI query model or the classification AI model.

The system includes a database in electronic communication with the server, the database including stored data, the stored data including: stored interaction that include one or more user queries, responses, and text, image, or voice data exchanged between the first user device and first user device.

The system's server is configured to route: a first set of parameters to in response to determining that a trust score is equal to or exceeds a threshold, and a second set of parameters to in response to determining that the trust score is below the threshold.

The system's server is configured to: output one or more retraining parameters including i) a conversation quality score generated by the system, that includes input from first user device and first user device.

The system's server is configured to: output at least one retraining parameter, the at least one retraining parameter including: i) an expert rank of the response, ii) an electronic instruction from the first user device regarding a quality of the response, and iii) a trust score received from the first user device.

The system's server is configured to output: a risk score generated by the system, the risk score indicative of a likelihood that a content of the response includes professional advice, the risk score configured to prioritize retraining of the response when risk score equals or exceeds a risk threshold.

In one aspect of the disclosure, a non-transitory computer-readable storage medium is described that includes instructions, which, when executed by one or more computer processors in a computer system coupled over a computer network, cause the one or more computer processors to perform operations including: receiving at a server, a query; passing, from the server, the query to a generative artificial intelligence (AI) query model; receiving, at the server, from the generative AI query model, a response; passing, from the server, the query and the response to a classification AI model; receiving, by the classification AI model, a classification of the query

and the response generated by generative AI query model; in response to the classification of the query and the response, matching the query and the response to a field of technical expertise; receiving, from the server and from a second user device, information in response to an interaction with an interactive user interface element; and generating a signal at the server establishing an electronic communication connection, using the information received in response to an interaction with the interactive user interface element, between a first user device communicatively coupled to the server and a second user device.

In some implementations, the operations include: outputting, using the field of technical expertise that is matched to the classification of the query and the response, an interactive user interface element to the second user device;

In some implementations, the operations include: receiving, at the server, query data from the second user device; transmitting the query to the generative AI query model; and receiving one or more output parameters from the generative AI query model and the classification AI model, the one or more output parameters including instructions for the second user device.

In some implementations, the operations include: converting the one or more output parameters to computer-readable instructions before transmission to the second user device; and converting at least one score received from the second user device to one or more input parameters configured for transmission by the server to facilitate retraining of one or more of the generative AI query model or the classification AI model.

In some implementations, the operations include: storing, at a database in electronic communication with the server, data indicative of an interaction that includes one or more user queries, responses, and text, image, or voice data exchanged between the first user device and second user device.

In some implementations, the operations include: routing i) a first set of parameters to in response to determining that a trust score is equal to or exceeds a threshold, and ii) a second set of parameters to in response to determining that the trust score is below the threshold.

In some implementations, the operations include: outputting one or more retraining parameters including: a conversation quality score generated by the processor, that includes input from first user device and second user device.

In some aspects of the disclosure, a method is described. The method includes receiving at a server, at the server, a query; passing, from the server, the query to a generative artificial intelligence (AI) query model; receiving, at the server, from the generative AI query model, a response; passing, from the server, the query and the response to a classification AI model; receiving, by the classification AI model, a classification of the query and the response generated by generative AI query model; in response to the classification of the query and the response, matching the query and the response to a field of technical expertise; receiving information in response to an interaction with an interactive user interface element; and generating a signal at the server to establish an electronic communication connection, using the information received in response to an interaction with the interactive user interface element, between a first user device and a second user device.

In some implementations, the method includes: outputting, using the field of technical expertise that is matched to the classification of the query and the response, an interactive user interface element to the second user device;

In some implementations, the method includes: receiving query data from the second user device and transmit the query to the generative AI query model; and receiving one or more output parameters from the generative AI query model and the classification AI model, the one or more output parameters including instructions for the second user device.

In some implementations, the method includes: converting the one or more output parameters to computer-readable instructions before transmission to the second user device; and converting at least one score received from the second user device to one or more input parameters configured for transmission by the server to facilitate retraining of one or more of the generative AI query model or the classification AI model.

The system described herein enables robust and accurate evaluation of generative neural networks for specific domains by utilizing curated example sets that minimize dataset contamination and improve assessment reliability. This approach allows for the identification and remediation of performance gaps in general-purpose generative neural networks, supporting supplemental training or finetuning with domain-specific data. As a result, the system achieves more computationally efficient and succinct answer generation, reduces response latency, and improves user experience by decreasing the need for iterative model calls and reducing battery and network usage.

One advantage of the system is the capability to enhance dynamic routing in mixture-of-experts architectures. By evaluating performance metrics for various generative neural networks across multiple domains, the system allows an expert routing model to effectively direct inputs to the generative neural network that aligns with the requirements of a specific domain. This targeted routing optimizes the process of generating predicted answers but also enhances the user experience by ensuring that each query is managed by the model most proficient in handling the domain in question. In some examples, the system preserves computational resources by enabling a user to obtain expert-verified AI-generated responses with fewer computation resources, such as searching and processing of searches, than would be obtained without the disclosed system.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for facilitating expert verification of AI-generated responses.

FIG. 2 is a flow diagram of a method for an exemplary expert verification process in the system shown in FIG. 1.

### DETAILED DESCRIPTION

Disclosed herein is a system and method for expert verification of system-generated AI-responses. In some implementations, the present disclosure provides illustrative examples of systems and methods for expert-in-the-loop verification benchmarking of AI-generated responses. The disclosed subject matter operates within the broader context of artificial intelligence systems, focusing on the categorization of user queries, routing to domain-specific experts, and facilitating expert verification of AI responses. This approach aims to ensure improved accuracy, trustworthiness, and actionable insights for users interacting with AI systems. The described architecture enables seamless integration of AI-driven response generation, expert verification, and user interaction, providing users with actionable and trustworthy information while maintaining efficiency and reliability.

Automated question-and-answer systems powered by artificial intelligence (AI) have become increasingly common, yet they are often limited by inaccuracies, insufficient contextual understanding, and a lack of reliable or actionable information. These limitations are exacerbated by the absence of real-time validation or expert oversight, which can erode user trust in AI-generated responses. Conventional systems do not provide effective means for users to verify AI outputs or escalate their queries to domain-specific professionals. Additionally, conventional approaches often lack robust mechanisms for categorizing and routing queries, resulting in inefficient or incorrect expert matching and delayed responses.

The present system overcomes these challenges by integrating AI-driven response generation and categorization with automated expert verification and user interaction. Upon receiving a user query, a generative AI model produces an initial response, which is then processed by a classification AI model to assign the query-response pair to a specific field of technical expertise. This categorization enables the system to route the interaction to a pool of qualified domain experts, who review the AI-generated response, assign a Trust Score™, and provide comments or clarifications. The Trust Score™, expert feedback, and expert credentials are then presented to the user, offering a transparent and reliable assessment of the AI response. In some implementations, the expert's photograph (e.g., headshot), experience, and academic credentials are retrieved from the expert data 111C and transmitted to the user device 102. The output processor 109 may retrieve and transmit expert data 11C between the server 110 and the user device 102. In some implementations, the Trust Score™ is color coded (e.g., red, yellow, green) in response to the value of the Trust Score™. For example, a Trust Score™ between 0-1 may receive a red color, a score between 2-3 may receive a yellow color, and a green color may be associated with a Trust Score™ between 4-5.

The system further enhances efficiency and reliability through automated query tagging, category-based routing, and interactive user interface elements that allow users to seamlessly escalate from AI-generated answers to expert-reviewed outputs. Machine learning models are employed to optimize categorization and expert matching, ensuring timely and accurate responses. All interactions, including Trust Scores™, expert comments, and user satisfaction data, are logged to create a comprehensive audit trail that supports ongoing refinement of the AI models and system processes. This architecture reduces the risk of AI-generated errors, provides users with actionable and trustworthy information, and establishes a clear pathway for expert intervention when needed.

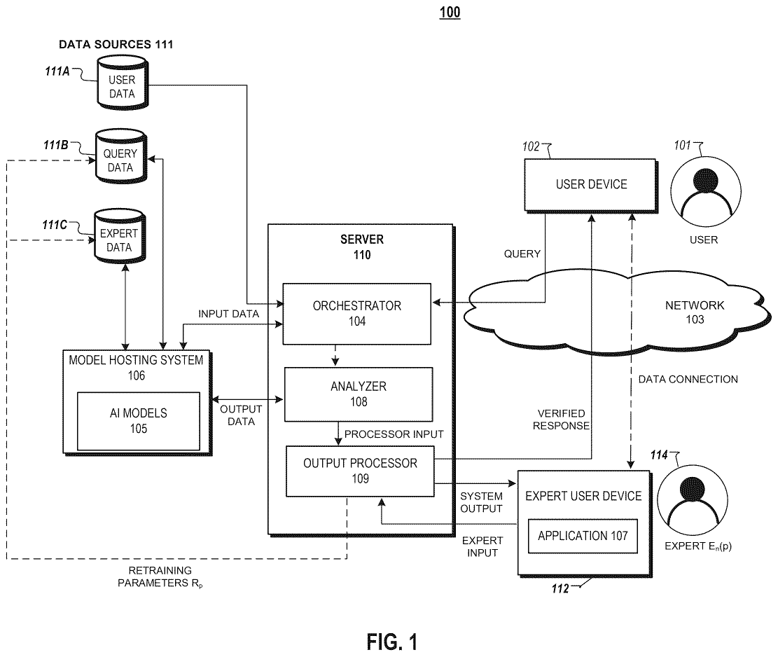

FIG. 1 shows a system 100 for facilitating expert verification of AI-generated responses. The system 100 integrates one or more artificial intelligence (AI) models 105, user interaction components, and expert verification mechanisms to ensure accurate and reliable responses to user queries. The system 100 includes a user device 102, and a server 110 having an orchestrator 104, an analyzer 108, and an output processor 109. The system 100 includes a model hosting system 106 coupled to the server 110. A computer network 103 communicatively couples the user device 102, expert user device 112, the server 110, and the model hosting system 106.

The process begins with a user 101 submitting a query through a user device 102. The user device 102 serves as the interface for the user 101 to input their query in natural language. The query is transmitted via the computer network 103 to a server 110, which orchestrates the subsequent operations. The computer network 103 facilitates communication between the user device 102, the server 110, and other system components. The input provided by the user to the user device 102 can include a query. For instance, the query can include a request for pet care advice, business advice, home improvement advice, legal advice, health advice, among other topics.

The user device 102 is a computing device that is capable of connecting to the system 100 through the computer network 103. The computer network 103 can include, e.g., a local area network, a personal area network, or a wide area network, such as the Internet, among others. The user device 102 may be operated by one or more computing devices of the system 100.

The input may be received by the orchestrator 104 from the user device 102. The orchestrator 104 may include one or more application programming interfaces that interact with the user device 102 and with the model hosting system 106. The orchestrator 104 receives the query data 111B. In some implementations, the orchestrator 104 may pass the received query to the model hosting system 106. In some implementations, the query may be transmitted from the orchestrator 104 to the analyzer 108, or the system 100 may parse the query between the analyzer 108 and the model hosting system 106. The orchestrator 104 functions as a data aggregation module for the server 110, receiving data from the data sources 111 and real-time data from the user device 102. The orchestrator 104 synthesizes these various data streams into a single structured representation of the user's query. The user's query is then provided as input to the model hosting system 106. In some implementations, the user's query is submitted to the analyzer 108.

In some implementations, the orchestrator 104 may receive the output from the model hosting system 106 and provide the output to the user device 102. For example, the system 100 may send an acknowledgement to the user device 102 that the query has been matched with an expert. The orchestrator 104 may store some or the entirety of the interaction between the user device 102 and the model hosting system 106. For instance, the orchestrator 104 may store in a database the initial query, any responses from the model hosting system 106, further queries from the user device 102, and additional responses from the model hosting system 106. In some cases, the orchestrator 104 will include with the output from the model hosting system 106 an interactive display option the user 101 can activate on the user device 102 to request expert verification of the output provided by the model hosting system 106.

The model hosting system 106 receives the user input and generates an output in response to the user's input. For instance, the model hosting system 106 may provide advice in response to a query. Alternatively, or in addition, the model hosting system 106 may generate a follow-up question for presentation to the user device 102. Upon selection of the request for expert verification, the model hosting system 106 may determine if the user 101 is a member authorized to access the expert verification service or is not a member. If the user 101 is not a member or is not logged in as a member to the service, the model hosting system 106 (or the orchestrator 104) will output an option for the user 101 to sign up or sign-in as a member to the expert verification service. The model hosting system 106 may be configured to handle receiving and storing user login information, as well as processing user payment information.

If the model hosting system 106 determines the user 101 is a member or is logged in to the expert verification service, the model hosting system 106 may pass some or all of the stored interaction, or a summary of the interaction, to the analyzer 108. The analyzer 108 receives the stored interaction and performs an automated one or more AI models 105 of the interaction between the user 101 and the model hosting system 106.

The model hosting system 106 includes one or more AI models 105 that process the query to generate an initial response. The one or more AI models 105 are trained on datasets derived from user data 111A, query data 111B, and expert data 111C, collectively referred to as data sources 111. The one or more AI models 105 leverage machine learning techniques to synthesize information and produce contextually relevant outputs. The one or more AI models include an AI-generated query model for generating AI-generated response(s) to user 101 queries, a categorization model for categorizing the AI-generated response (e.g., answer), and an expert routing model for determining and routing the AI-generated response to an expert for verification. The one or more AI models 105 may include one or more autoregressive models, one or more autoencoder models, one or more sequence-to-sequence models, and/or one or more general-purpose large language models.

The user data 111A may include use preferences, user device settings, biographical information, payment information, and location data. In some implementations, user data 111A may include electronic connection preferences. Query data 111B can include information in one or more languages, such as definitions, summaries, grammatical, syntax, and sentence structure rules, academic or professional studies and reports, subject-matter specific documents, literary references, and the like. Expert data 111C includes a corpus of vetted experts and their credentials, such as education, areas of expertise, and links to professional websites or publications. In some implementations, expert data 111C may include electronic connection preferences. Potential experts may be subject to credential review, surveys, and interviews before being added to the expert data 111C.

The output from the AI models 105 is analyzed by the analyzer 108 within the server 110. The analyzer 108 evaluates the AI-generated response and categorizes the query-response pair into a specific field of technical expertise. This categorization enables routing the interaction to the appropriate domain-specific expert pool. The analyzer 108 also generates processor input for further processing by an output processor 109.

Upon receiving an output from the model hosting system 106, the analyzer 108 manages the logic and decision-making workflows of the routing and/or categorization. Managing decision-making workflows may include analyzing the context data to determine one or more commands indicating the next logical step in expert matching and/or routing. Using this analysis, the analyzer 108 generates data (e.g., parameters, commands, or prompts) for sending to the model hosting system 106.

The output processor 109 converts the analyzed data into system output and transmits the system output to an expert user device 112. The expert user device 112 is associated with an expert 114, who reviews the AI-generated response using an application 107. The expert 114 may be represented as Ep (n), where p represents an area of expertise and n represents a unique number associated with a given expert. The number n, in some implementations, may be associated with the expert's credentials and p may be a numerical representation of a field of expertise. The values of p and n may be parameters that the one or more models 105 use to determine matching and routing of the Ai-generated responses.

The application 107 presents the expert 114 with the entire conversation, including the user query and AI response, facilitating a thorough evaluation. The expert 114 reviews the AI-generated response and assigns a Trust Score™. In some implementations, the expert 114 via the expert user device 112 provides comments or clarifications, which are transmitted back to the server 110 as expert input to the output processor 109. The expert's input may include quality information, such as whether the AI-generated response is considered miscategorized (e.g., routed to the wrong expert), safe, complete, incomplete, misleading, or can be flagged as including risk to being interpreted as professional advice or a medical, legal, engineering, physiological, or other professional nature. This quality information may be used to generate one or more retraining parameters Rp.

In some implementations, the system 100 may generate one or more of a conversation quality (CQ) score and an expert quality (EQ) score. Using the EQ score, experts 114 are assigned to tiers, e.g., platinum, gold, silver, and bronze tiers. The EQ score may be generated based on the CQ score. One or more AI models 105, such as the expert routing model, may be updated in real-time each time a CQ score is calculated. In some implementations, if one or more of the Trust Score™ or CQ score is equal to or exceeds a threshold value, the AI-generated response may be assigned as ground truth data, or used in reinforced learning, or evaluations. If the Trust Score™ or CQ score is below the threshold value, the system 100 may generate an alternative answer. In some implementations, the system 100 prompts the expert 114 to determine what changes would make the AI-generated response correct or complete. This updated response (e.g., corrected or completed AI-generated response) may be transmitted to the user device 102 for display to the user 10. The updated response may be used to retrain the query data 111B, and expert data 111C.

For example, the output processor 109 may receive model output data from the model hosting system 106 through the analyzer 108. Operations performed by the output processor 109 are guided by the original query. The output-processing may involves parsing the model output (e.g., by extracting a specific parameter value or a token) and combining the model output with data indicating the original query, the categorization of the AI-generated response, and expert matching and routing information to generate command-specific executable instructions. In some implementations, the command-specific executable instructions generated by the output processor 109 are structured data objects that translate into machine-readable commands for outputting information to the expert user device 112.

The server 110 compiles the expert-reviewed outputs, including the Trust Score™, comments, and expert credentials, and sends them back to the user device 102 via the network 103. The user 101 receives the verified response, which includes the expert's evaluation, fostering transparency and trust in the system's 100 AI-generated responses.

Throughout the process, retraining parameters Rp are generated based on the interactions and stored in the data sources 111. These retraining parameters Rp are used to refine the AI models 105, ensuring continuous improvement in response quality and categorization accuracy. The system logs all interactions, including conversation data, Trust Scores™, and expert feedback, creating a comprehensive audit trail for system refinement and performance evaluation. These logs can be used by the server 110 to generate retraining parameters Rₚ. retraining parameters Rp may include one or more of an expert rank, data indicating a quality of the response, a Trust Score™ received from the second user device.

In some implementations, the system 100 records a time period that it takes the expert to respond to the AI-generated response. If the system 100 determines that the expert's response time is below a threshold response time, the system can generate a flag and associate the flag with the expert. For example, the output processor 109 may determine the time period, and automatically generate a flag if the expert's response time is less than the time period. The flag can be transmitted to the expert data 111C by the output processor 109. The response time of the expert can be parameterized and used to retrain the one or more AI models 105. For example, if the Trust Score™ is submitted before the threshold response time, a flag is generated. Where the time period of response meets or exceeds the threshold response time, the flag may not be generated. Both scenarios may be parameterized and used to retrain the one or more AI models 105.

The described architecture enables seamless integration of AI-driven response generation, expert verification, and user interaction, providing users with actionable and trustworthy information while maintaining efficiency and reliability. The examples or implementations described herein are provided for illustrative purposes only and are not intended to limit the scope of the described subject matter. Furthermore, various modifications, rearrangements, or alternative implementations of the described systems and methods may be made without departing from the spirit and scope of the subject matter as defined by the claims.

Categorization of the stored interaction may include, e.g., identification of the topic with which the user query or the stored interaction pertains (e.g., pet care, legal, health, finance, home improvement, etc.). Categorization, using one or more AI models 105, may include further sub-categorization to which the stored interaction pertains. For instance, sub-categorization may include identification of a sub-area of healthcare, law or finance to which the stored interaction pertains. The sub-categorization may include identification of a particular area of expertise or a particular type of expert that is best suited to evaluate the interaction. To perform the categorization, the analyzer 108 may include one or more classification machine learning models. The machine learning models may include one or more linear models, probabilistic models, tree-based models, kernel-based models, instance-based models, ensemble models, and/or neural network based models, such as convolutional neural networks or recurrent neural networks. The one or more models may be trained on training data that includes example interactions between users and one or more AI models 05. In some implementations, the analyzer 108 may generate a summary of the stored interaction with the user 101.

The system 100, in some implementations, may generate a risk score with the response. For example, the model hosting system 106 may include a model that assigns the AI-generated response a risk score associated with a likelihood that the response includes content which may be interpreted by a user as technical or professional advice. The risk score indicates a likelihood that a content of the response includes professional advice. For example, an AI-generated response that addresses the legality of a state-specific regulatory or medical question, may be assigned a higher risk score than a response that does not address the legality of the medical or regulatory question. When the risk score equals or exceeds a risk threshold, the system 100 assigns a higher priority to the AI-generated response. AI-generated responses that meet or exceed the risk threshold are prioritized for retraining above responses that are assigned a value below the risk threshold. In some examples, data associated with a certain risk score, expert rank, or categorization may be used to determine a queue priority for retraining the query data 111B, and expert data 111C using the outputs (e.g., AI-generated response, Trust Score™, CQ score, risk score, expert rank, EQ score, categorization, etc.) of output processor 109.

One or more experts 114 may login to the system 100 at various times throughout their day through the application 107. The experts 114 that have been previously vetted and that have signed up to provide services as a reviewer may have been previously labeled by the system 100 with one or more tags to identify their respective areas of expertise. Such labels may be stored by the system 100 and be used by the system 100 to determine who is allowed to provide expert feedback to users 101.

Upon categorizing the stored interaction, the analyzer 108 and/or the application 107 may use the categorization information generated by the analyzer 108 to select from a database one or more available technical experts, e.g., according to their previously stored expertise labels, for evaluating the stored interaction. For example, in some implementations, the analyzer 108, and or the application 107 will have categorized a user interaction as relating to pet care, and specifically relating to sub-categories of canine veterinary dentists for canines. Using these categorizations, the analyzer 108, and or the application 107 will identify one or more technical experts in the field of canine dentistry. Once the experts are identified, the application 107 may output to its user interface an option (e.g., an interactive link) for the identified experts to review and provide feedback on the stored interaction or the summary of the stored interaction. The application 107 may output an option for the identified experts also to connect through the system 100 with the user 101. For instance, the application 107 may allow the technical expert to enter comments and responses that are then transmitted through the system 100 to the user device 102. Other methods of allowing the expert to connect with the user 101 are also possible.

In some implementations, the system 100 does not select technical experts based on the categorization. Instead, the application 107 may be configured such that technical experts can opportunities to provide expert feedback for those queries that have been tagged with categorization labels that match the technical expert's area of expertise. For instance, in some cases, the application 107 may output to a user interface different pages or landing sites, where each landing site is associated with a specific technical category and/or sub-category (e.g., health care, law, finance, etc.). A technical expert will be able to view the pages and/or landing sites that match the expert's area of expertise, so that experts from one field cannot provide feedback on fields in which they are not experts. Within the landing sites and/or pages, the application 107 offer options (e.g., interactive links) through which the expert can review the stored user interaction and/or a summary of the stored interaction. If the expert decides to offer their feedback, the application 107 may be configured to allow the expert to connect with the user 101.

Throughout the process, retraining parameters Rp (e.g., AI-generated response, Trust Score™, CQ score, risk score, expert rank, EQ score, categorization) are generated based on the interactions and stored in the data sources 111. These parameters are used to refine the AI models 105, ensuring continuous improvement in response quality and categorization accuracy. The system logs all interactions, including conversation data, Trust Scores™, and expert feedback, creating a comprehensive audit trail for system refinement and performance evaluation.

Although various components of system 100 are shown as separate elements (e.g., orchestrator 104, model hosting system 106, analyzer 108, output processor 109, and application 107), some or all of these elements may be understood to a single component or may be organized in a manner different from that shown. The elements of system 100 shown in FIG. 1 may operate on one or more computing devices that include one or more processors and memory. For example, the computing devices may be located in the same general location or may be located in one or more different locations and may be connected through one or more networks. Although model hosting system 106 is shown as being part of system 100, in some cases, model hosting system 106 is separate from system 100 and may be understood to be a third-party service that system 100 interacts with through sending and receiving information, as described herein.

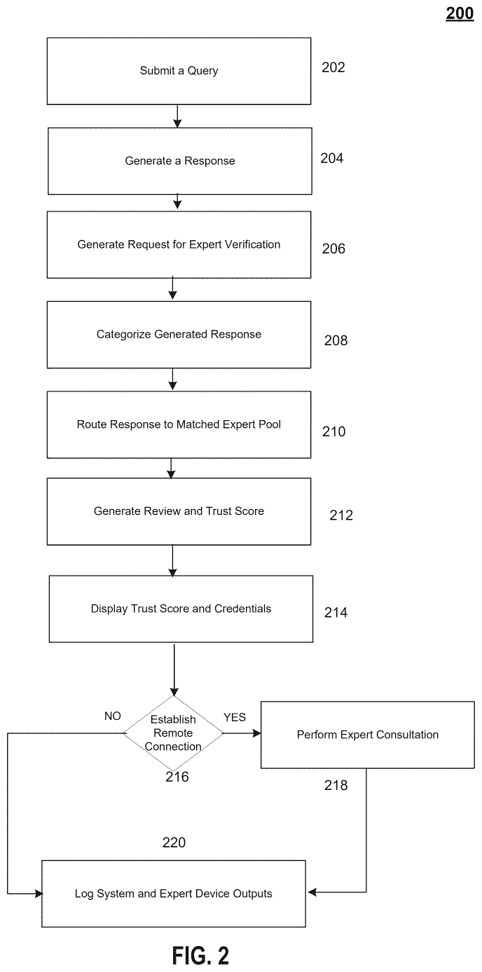

FIG. 2 is a flow diagram of an example method 200 for generating expert verification of AI-generated responses in the system 100 shown in FIG. 1 The method 200 begins at operation 202, where a user submits a natural language query through an interactive interface. This query serves as the initial input to the system, initiating the workflow. At operation 204, the system generates a response using a generative AI model based on pre-trained data. This response is tailored to the user's query and represents the first automated output of the system.

At operation 206, the system generates a request for expert verification. This request may be triggered automatically or by user action, such as actuating a specific user interface (UI) element. The request initiates the expert verification process, ensuring that the AI-generated response undergoes human review by an expert for accuracy and reliability.

At operation 208, the system categorizes the AI generated responses. An AI categorization model analyzes the user query and the AI response, classifying the interaction into a specific domain, such as legal, medical, or technical. The categorization model generates routing labels that facilitate precise matching of the query-response pair to the appropriate field of expertise.

At operation 210, the system routes the AI-generated response and routes to an AI matching model. The AI matching model matches the response to an expert whose expertise aligns with the assigned category labels. The routing mechanism ensures that the interaction is directed to domain-specific professionals who possess the necessary qualifications to evaluate the AI-generated response. This operation may involve ranking experts based on historical performance metrics, customer satisfaction scores, and conversation quality evaluations.

At operation 212, the system generates a request for the expert to review the categorized, AI-generated response. The expert reviews the response and generates a Trust Score™. The Trust Score™ is typically assigned on a scale of 1 to 5 and reflects the accuracy and reliability of the AI response. Additionally, the expert may provide qualitative feedback, such as comments or clarifications, to enhance the response. This hybrid review process combines human judgment with AI-generated outputs, creating a robust verification mechanism.

At operation 214, the Trust Score™ and expert credentials are displayed to a first user device. The first user device is used to generate the original natural language query. This operation establishes transparency and trust by showcasing the qualifications of the reviewing expert. The user can evaluate the Trust Score™ and feedback to determine the reliability of the information provided.

At operation 216, the system generates a user interface element for the first user. The user interface element gives the user the option to remotely connect with the expert or not to make a remote connection and terminate the session. The expert has a second user device. If the user chooses to connect, the system establishes synchronous communication between the first user device and the second user device, enabling further interaction and personalized advice. If the user declines to generate a remote session with the expert, the method 200 proceeds to operation 220. In some implementations, the interactive user interface elements may be a graphical user interface (GUI), which may include images, text boxes, and other embedded objects configured to receive user input.

At operation 218, the user and expert may connect via a consultation session using chat box, voice, or video. Voice data, text data, image data, and data about the type and quality of the connection can be logged with each consultation session. Data about the communication session can be labelled as stored interaction data. This operation allows for real-time expert consultation, providing the user with actionable guidance tailored to their specific needs. In some implementations, the system may generate a signal before that enables the user device to connect with the expert user device.

At operation 220, the system stores the AI-generated response, Trust Score™, and stored interactions in logs. The logs may also include payment information, information, and surveys from the user and/or expert. This includes the conversation history, expert metadata, satisfaction surveys, payment processing details, and any stored interaction data generated during the consultation session, such as voice, text, image, or connection quality data. The logged data serves multiple purposes, such as auditing system performance, refining AI models, and improving expert matching algorithms. By maintaining a detailed audit trail, the system promotes accountability and supports ongoing enhancement of the processes involved. For example, the logs may store one or more retraining parameters Rp used to retrain the query data 111B, expert data 111C, or both.

This specification uses the term “configured” in connection with systems and computer program components. For a system of one or more computers to be configured to perform particular operations or actions means that the system has installed software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of the disclosure or on the scope of what may be claimed, but rather as descriptions of features that may be specific to particular implementation. Certain features that are described in this specification in the context of separate implementations can also be implemented in combination in a single embodiment. Conversely, various features that are described in the context of a single embodiment can also be implemented in multiple implementations separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
a server communicatively coupled to a computer network, the server configured to:
receive, at the server, a query;
pass the query to a generative artificial intelligence (AI) query model;
receive, from the generative AI query model, a response;
pass the query and the response to a classification AI model;
receive, by the classification AI model, a classification of the query and the response generated by the generative AI query model;
in response to the classification of the query and the response, match the query and the response to a field of technical expertise;
receive information in response to an interaction with an interactive user interface element; and
generate a signal at the server to establish an electronic communication connection, using the information received in response to the interaction with the interactive user interface element, between a first user device and a second user device.

2. The system of claim 1, wherein the server is configured to:
output, using the field of technical expertise that is matched to the classification of the query and the response, an interactive user interface element to the second user device.

3. The system of claim 1, wherein the server is configured to:
receive query data from the second user device and transmit the query to the generative AI query model; and
receive one or more output parameters from the generative AI query model and the classification AI model, the one or more output parameters including instructions for the first user device.

4. The system of claim 3, wherein the server comprises:
an output processor electronically coupled to an analyzer, the output processor configured to:
i) convert the one or more output parameters to computer-readable instructions before transmission to the first user device, and
ii) convert at least one score received from the first user device to one or more input parameters configured for transmission by the output processor to facilitate retraining of one or more of the generative AI query model or the classification AI model.

5. The system of claim 1, comprising:
a database in electronic communication with the server, the database comprising stored data, the stored data including: stored interaction that include one or more user queries, responses, and text, image, or voice data exchanged between the first user device and first user device.

6. The system of claim 1, wherein the server is configured to route:
a first set of parameters to in response to determining that a trust score is equal to or exceeds a threshold, and
a second set of parameters to in response to determining that the trust score is below the threshold.

7. The system of claim 1, wherein the server is configured to:
output one or more retraining parameters including i) a conversation quality score generated by the system, that includes input from first user device and first user device.

8. The system of claim 1, wherein the server is configured to:
output at least one retraining parameter, the at least one retraining parameter including:
i) an expert rank of the response,
ii) an electronic instruction from the first user device regarding a quality of the response, and
iii) a trust score received from the first user device.

9. The system of claim 8, wherein the server is configured to output:
a risk score generated by the system, the risk score indicative of a likelihood that a content of the response includes professional advice, the risk score configured to prioritize retraining of the response when risk score equals or exceeds a risk threshold.

10. A non-transitory computer-readable storage medium comprising instructions, which, when executed by one or more computer processors in a computer system coupled over a computer network, cause the one or more computer processors to perform operations comprising:
receiving, at a server, a query;
passing, from the server, the query to a generative artificial intelligence (AI) query model;
receiving, at the server, from the generative AI query model, a response;
passing, from the server, the query and the response to a classification AI model;
receiving, by the classification AI model, a classification of the query and the response generated by generative AI query model;
in response to the classification of the query and the response, matching the query and the response to a field of technical expertise;
receiving information in response to an interaction with an interactive user interface element; and
generating a signal at the server establishing an electronic communication connection, using the information received in response to an interaction with the interactive user interface element, between a first user device communicatively coupled to the server and a second user device.

11. The non-transitory computer-readable storage medium of claim 10, the operations comprising:
outputting, using the field of technical expertise that is matched to the classification of the query and the response, an interactive user interface element to the second user device.

12. The non-transitory computer-readable storage medium of claim 10, the operations comprising:
receiving, at the server, query data from the second user device;
transmitting the query to the generative AI query model; and
receiving one or more output parameters from the generative AI query model and the classification AI model, the one or more output parameters including instructions for the second user device.

13. The non-transitory computer-readable storage medium of claim 12, the operations comprising:
converting the one or more output parameters to computer-readable instructions before transmission to the second user device; and
converting at least one score received from the second user device to one or more input parameters configured for transmission by the server to facilitate retraining of one or more of the generative AI query model or the classification AI model.

14. The non-transitory computer-readable storage medium of claim 10, the operations comprising:
storing, at a database in electronic communication with the server, data indicative of an interaction that includes one or more user queries, responses, and text, image, or voice data exchanged between the first user device and second user device.

15. The non-transitory computer-readable storage medium of claim 10, the operations comprising routing:
i) a first set of parameters to in response to determining that a trust score is equal to or exceeds a threshold, and
ii) a second set of parameters to in response to determining that the trust score is below the threshold.

16. The non-transitory computer-readable storage medium of claim 10, the operations comprising:
outputting one or more retraining parameters including: a conversation quality score generated by the processor, that includes input from first user device and second user device.

17. A method comprising:
receiving at a server, at the server, a query;
passing, from the server, the query to a generative artificial intelligence (AI) query model;
receiving, at the server, from the generative AI query model, a response;
passing, from the server, the query and the response to a classification AI model;
receiving, by the classification AI model, a classification of the query
and the response generated by generative AI query model;
in response to the classification of the query and the response, matching the query and the
response to a field of technical expertise;
receiving information in response to an interaction with an interactive user interface element; and
generating a signal at the server to establish an electronic communication connection, using the information received in response to an interaction with the interactive user interface element, between a first user device and a second user device.

18. The method of claim 17, comprising:
outputting, using the field of technical expertise that is matched to the classification of the query and the response, an interactive user interface element to the second user device.

19. The method of claim 17, comprising:
receiving query data from the second user device and transmit the query to the generative AI query model; and
receiving one or more output parameters from the generative AI query model and the classification AI model, the one or more output parameters including instructions for the second user device.

20. The method of claim 19, comprising:
converting the one or more output parameters to computer-readable instructions before transmission to the second user device; and
converting at least one score received from the second user device to one or more input parameters configured for transmission by the server to facilitate retraining of one or more of the generative AI query model or the classification AI model.
